(19) United States
(12) Patent Application Publication
(10) Pub. No.: US 2014/0322659 A1
(43) Pub. Date: Oct. 30, 2014

(54) Heating Apparatus And Method For Treatment Of Weeds

(71) Applicant: Bo WINTERSKOV, Nyborg (DK)

(72) Inventor: Bo WINTERSKOV, Nyborg (DK)

(21) Appl. No.: 14/258,230

(22) Filed: Apr. 22, 2014

Related U.S. Application Data
(63) Continuation-in-part of application No. 13/678,985, filed on Nov. 16, 2012.
Application No. 13/678,985 is a continuation of application No. PCT/DK2011/000047, filed on May 18, 2011.

(30) Foreign Application Priority Data
May 20, 2010 (DK) PA2010 00441

(51) Int. Cl. A01M 21/00; F23D 14/36; A01M 21/04

(52) U.S. Cl. CPC A01M 21/00; A01M 21/04; F23D 14/36
USPC 431/158

(57) ABSTRACT

A heat gun for treating a surface to destroy weeds and unwanted vegetation uses a lightweight jet engine to generate a hot blast of combustion exhaust, with an optional injector in an engine jacket arranged over the jet engine admixing water with the hot exhaust. The combustion exhaust is discharged through an exhaust nozzle and directed by a shield downwardly into contact with the surface to be treated. The engine is controlled electronically and advanced on a lightweight frame, which may be fitted with a ballast weight and spacer wheels, or be mounted on an advancing arrangement. The jet engine is powered by liquid fuel supplied from a tank. Intake air is cleaned and sound-damped in a filter unit. Combustion takes place at a high pressure and the exhaust discharged hot in a high velocity exhaust stream which instantaneously destroys weeds and unwanted vegetation in the soil contacted therewith.

### CROSS-REFERENCE TO RELATED APPLICATIONS

This application is a continuation in part of U.S. application Ser. No. 13/678,985, having a filing date of 16 Nov. 2012, which was a continuation of PCT International patent application no. PCT/DK2011/000047, filed 18 May 2011, claiming priority in Danish patent application no. PA2010 00441, filed 20 May 2010, the contents of which are hereby incorporated by reference.

### TECHNICAL FIELD

The invention relates to a tool for surface treatment by cleaning and drying of surfaces, joints and the like, where the intention is to remove weathering, wear or unintentionally added coatings prior to further surface treatment, if any. In addition, the invention relates to a method and apparatus for treating surfaces to destroy weeds and other unwanted vegetation.

### BACKGROUND

Mutually independent systems are often used in the methods known today for the cleaning and heat treatment of surfaces and items. First, cleaning is performed by a high-pressure system with water or air directly or with admixture of cleaning agents, such as, by way of example, sand, and subsequently heat treatment is performed with gas burners with a naked or indirect flame. In principle, the known technique has all the requisite characteristics, but it is inexpedient to first employ heavyweight high-pressure systems powered by diesel or petrol engines, which discharge heat directly into the environment through their exhaust and cooling systems, and to then employ a second source of energy for subsequent heat treatment by gas burners supplied from pressurized gas systems, which, in addition to the drawback of handling and transporting “hazardous goods”, now also constitute a serious security problem due to the risk of terrorism, which has led to the imposition of very severe security requirements and restrictions for workplaces which use and store gas in pressurized cylinders and tanks.

It is known from patent publication GB 614725A to employ hot exhaust air generated by the exhaust of a jet engine, which, after being discharged through a pipe and hose system, is admitted to a work area where a dosing device for the admixture of sand or the like is added to an exhaust nozzle, which can thus clean by sandblasting.

### SUMMARY OF THE INVENTION

The invention provides an effective tool for cleaning and heat treatment in one operation, whereby disadvantages of the known technique are remedied. This is achieved in accordance with the invention by using a lightweight turbojet engine with an engine jacket with a connecting member, which, supplied with an aggregate injector, is capable of dosing one or more aggregate materials into the exhaust jet, which thereby cleans and dries the blasted area while being advanced manually or by a self-propelling unit.

The invention additionally provides an effective tool for using the heat of an exhaust gas stream discharged from a turbojet engine for treating a surface for destroying weeds and/or other unwanted vegetation, without the necessity to use any chemicals or other environmentally unfriendly substances.

The invention uses a lightweight jet engine in which a liquid fuel, such as, by way of example, petrol or diesel oil, is injected under electronic control into a compressed combustion chamber, out of which the combustion exhaust is discharged from the engine jacket with an injector for optional addition of water for forming steam, which is dosed and discharged through one or more exhaust nozzles to the surface to be treated. The jet engine sucks in clean air through a dirt and noise reducing filter unit, which may be mounted directly on and around the engine unit, or be disposed at a distance from the treatment area, supplying clean air through a system of hoses or the like. The exhaust nozzle may be adapted for various tasks, for example narrow and pointed for depth treatment of joints and cracks, or flat and wide for broader area weed treatment. When the jet exhaust is directed at an item to be treated, the exhaust nozzle may be affected strongly by an oppositely directed impact which will attempt to lift the nozzle off the item, and therefore it may be expedient to use an adjustable ballast weight and spacer wheels to facilitate advance and to maintain a suitable distance between the nozzle and the surface. The tool may be constructed for simple manual operation, mounted on a lightweight frame or trolley, or a number of these may be mounted together on a self-propelled, manned or remote-controlled advancing arrangement.

### BRIEF DESCRIPTION OF THE DRAWINGS

The invention will be explained more fully below with reference to the drawing, in which:

FIG. 1 shows one embodiment of a heat gun according to the invention for simple operation, with fuel and aggregate in a lightweight arrangement, which are admitted through hose connections not shown here;

FIG. 2 shows another embodiment with multiple heat guns mounted in an arrangement which may be mounted on a self-propelled, manned vehicle, or be advanced under remote control;

FIG. 3 shows an alternative embodiment of the invention adapted for treating surfaces to destroy weeds and other unwanted vegetation;

FIG. 4 is a cross sectional view thereof; and,

FIG. 5 illustrates a typical control panel.

### DETAILED DESCRIPTION OF THE INVENTION

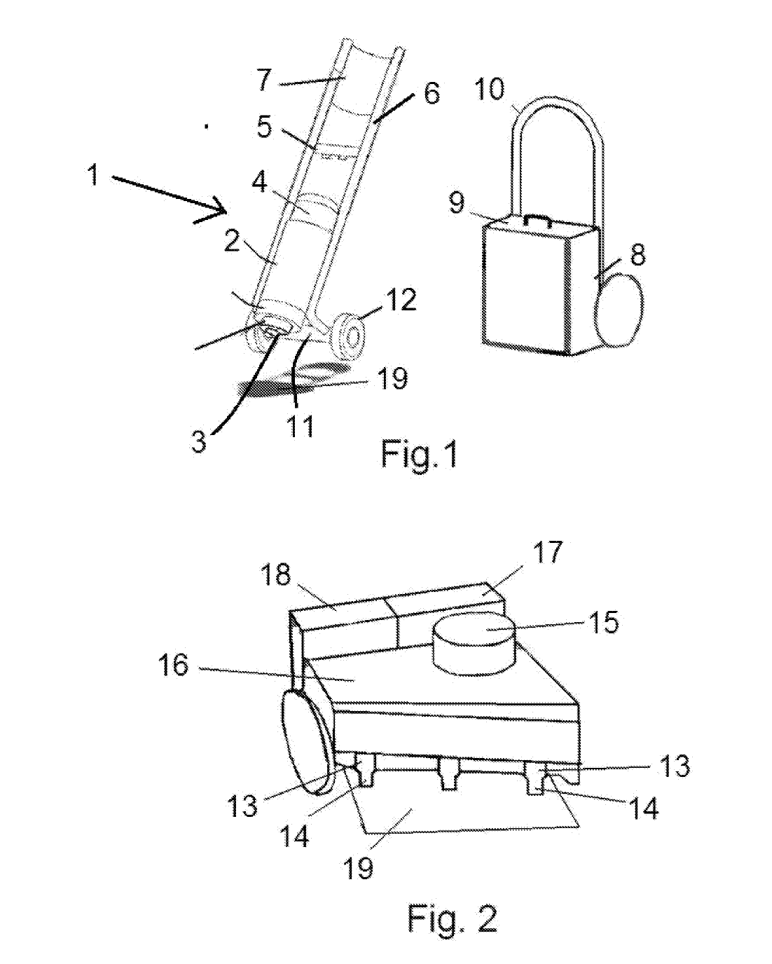

FIG. 1 shows a heating apparatus 1 with a lightweight turbojet engine mounted under an engine jacket 2, with an aggregate injector for admitting cleaning medium into the hot exhaust jet, which is discharged through an exhaust nozzle 3. The intake air is passed through an air and noise filter unit 4, and the jet engine is controlled here by a control device disposed in a handle 5. Everything is mounted here on a simple lightweight and mobile frame 6 with an armrest 7. A fuel tank 8 and an aggregate container 9 are carried along on a lightweight trolley 10. Here, the heating apparatus is shown fitted with an adjustable ballast weight 11 and adjustable load-relieving and spacer wheels 12.

FIG. 2 shows a second embodiment of the heating apparatus with multiple engine units 13, with exhaust nozzles 14 and an intake filter 15, here mounted in an advancing arrangement 16 which has containers to carry along fuel 17 and aggregate materials 18. Here, everything is advanced and controlled from a self-propelled, manned or remote-controlled unit, not shown, with the combustion exhaust directed against the surface 19.

A heating apparatus for the cleaning and heat treatment of surfaces, joints and the like using hot blast air generated by a turbojet engine, is characterized by an engine jacket (2) with an injector for admixture of a cleaning medium which is discharged through an exhaust nozzle (3). Intake air may be supplied to the engine through an air filter unit (4). The heat gun may be set up on a lightweight frame for manual advance. Alternatively, the heat gun may include one or more engine units (13) mounted in an advancing arrangement (16). In one embodiment, the exhaust nozzle (3) is configured as a long narrow nozzle for the treatment of cracks and joints. In another, the exhaust nozzle (3) is configured as a short wide nozzle for the cleaning and heat treatment of surfaces. The heating apparatus may include an adjustable ballast weight (11), mounted to counteract lifting on application of force from the exhaust nozzle (3) and/or be fitted with adjustable load-relieving and spacer wheels (12).

In one embodiment of the invention, a heat gun for the cleaning and heat treatment of surfaces, joints, cracks and the like uses a hot blast jet produced by the exhaust jet of a jet engine, where aggregate injectors have been added in the engine jacket for the admixture of a cleaning medium, such as sand, granulate material or liquid. The heat gun exhibits a lightweight jet engine arranged under an engine jacket, with an aggregate injector, which is capable of dosing a cleaning medium admitted into the hot exhaust jet, for discharge through an exhaust nozzle directed at the item to be treated. The engine is controlled electronically by a control device and is advanced on a lightweight frame, which may be fitted with a ballast weight and spacer wheels, or be mounted on an advancing arrangement. The turbojet engine is powered by liquid fuel supplied from a tank. Intake air is cleaned and sound-damped in a filter unit, and the combustion takes place at a high pressure and is discharged hot and in a high velocity exhaust jet, into which the cleaning media is fed from a tank.

In another embodiment of the invention, a heating apparatus for the treatment of surfaces to destroy weeds or other unwanted vegetation uses a hot blast of combustion exhaust produced by the turbojet engine, optionally including water injectors in the engine jacket for the admixture of water to produce steam.

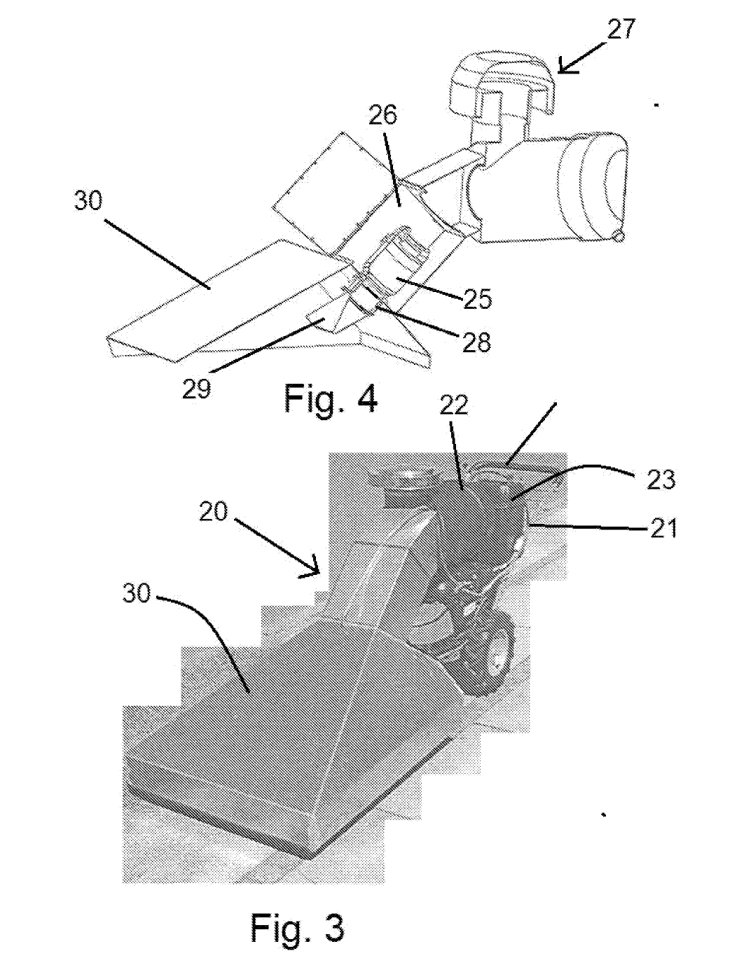

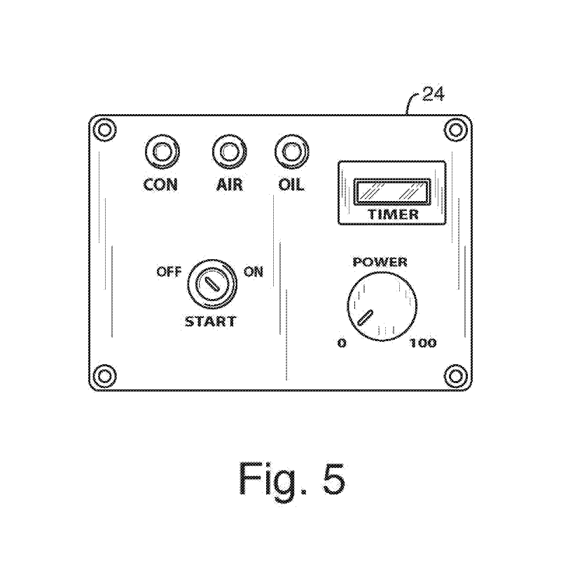

Referring to FIG. 3, another version of a heating apparatus 20 in accordance with the present invention is shown that has a frame 21 supporting a fuel container 22, a water container 23 and a control panel 24 (shown in FIG. 5), which supports a lightweight jet engine 25. With reference to FIG. 4, a cross sectional view is shown, which shows the jet engine 25 arranged under an engine jacket 26. Air is received through an air intake filter 27 which is mixed with fuel in the jet engine and combusted to generate an exhaust stream, the combustion taking place at a high pressure and the exhaust discharged hot and at a high velocity, which passes by a liquid injector 28, which is capable of dosing water into the hot exhaust for discharging both steam and the exhaust through an exhaust nozzle 29 directed and contained within a heat shield 30 which assures downward distribution of the combustion exhaust over the surface desired to be heated.

In an exemplary embodiment, the jet engine is capable of delivering from 3 to 20 m³/min of exhaust, at temperature of about 500 degree C., with the engine speed being controllable within a range of from 30-60,000 rpm. Of course, the size and discharge of the jet engine selected for use may depend on the application, whether one or more jet engines will be used, the size of the area to be treated and manner of moving, whether manual or mechanically driven, and these parameters are not limiting as to the applicant's invention.

If water is being supplied to additionally mix steam with the exhaust stream, given the above parameters, about 15-30 liters per hour may be consumed. Generally, the heat gun in this embodiment has the capacity to treat between 2000 and 4000 m²/hr, though this may vary depending on the exhaust directing arrangement, whether larger or smaller.

It has been found that the apparatus according to the invention is effective not only in killing the weeds and vegetation above the surface but also destroys the root systems, and so it is a quick and effective way to clear vegetation from walkways, drive ways, for preparing areas for re-seeding, reclaiming areas after brush or other vegetation has been cut down. The particular advantage is that no chemicals are needed as heat and steam are the agents which penetrate into the treated soil to destroy and eliminate the unwanted growth down into the roots.

The invention thus also encompasses a method for treating a surface to destroy weeds and unwanted vegetation including the steps of providing a jet engine for discharging a combustion gas exhaust, mounted on a frame movable over the surface to be treated, directing the combustion gas exhaust towards the surface, contacting and instantaneously heating the weeds and unwanted vegetation with the combustion exhaust gas which are destroyed thereby, and moving the heat gun over the entire surface for destroying the weeds and vegetation associated therewith.

Optionally, the method further comprises mixing water with the combustion exhaust gas for generating steam, and contacting and instantaneously heating the weeds and unwanted vegetation with the mixture of the combustion exhaust gas and steam which are destroyed thereby.

The engine is controlled electronically from the control panel which includes indicators, as well as start, stop and an adjustable power control. A water level indicator and timer are also included. This embodiment of the heat gun is advanced manually. The frame may optionally be fitted with a ballast weight, as described relative to the previous embodiment to offset the thrust force of the jet engine exhaust.

While preferred embodiments of the present invention are shown and described, it will be understood by those skilled in the art that various changes or modification can be made without varying from the spirit and scope of the invention.

1. A heat gun for treating a surface to destroy weeds and unwanted vegetation comprising:
a turbojet engine for generating a combustion exhaust which is discharged through an exhaust nozzle disposed adjacent the surface to be treated;
an engine jacket disposed about the turbojet;
a movable frame for supporting the turbojet engine and engine jacket; and,
a shield for containing and directing the combustion exhaust over a predetermined area of the surface, the combustion exhaust simultaneously heating and destroying weeds and unwanted vegetation contacted thereby.

2. The heat gun according to claim 1 further comprising an injector for admixture of water with the combustion exhaust which are together discharged through the exhaust nozzle

3. The heat gun according to claim 1, further comprising two or more jet engines and engine jackets are mounted together on the frame in an advancing arrangement.

4. The heat gun according to claim 1, further comprising an air filter unit for filtering intake air supplied to the turbojet engine.

5. The heat gun according to claim 1, wherein the shield has a narrow outlet for discharging the combustion velocity exhaust into cracks and joints.

6. The heat gun according to claim 1, wherein the shield has a wide outlet for discharging the combustion exhaust against a corresponding wide area of the adjacent surface.

7. The heat gun according to claim 1, further comprising wheels attached to the frame for supporting movement of the heat gun during discharge of the combustion exhaust.

8. The heat gun according to claim 1, wherein the frame is a lightweight frame adapted for manual advance of the turbojet engine and engine jacket over the surface.

9. The heat gun according to claim 1, further comprising an adjustable ballast weight, mounted to counteract a lifting force from discharge of the combustion exhaust against the surface receiving the treatment.

10. A method for treating a surface to destroy weeds and unwanted vegetation comprising:
providing a turbojet engine for discharging a combustion gas exhaust, mounted on a frame movable over the surface to be treated;
directing the combustion gas exhaust towards the surface, contacting and instantaneously heating the weeds and unwanted vegetation with the combustion exhaust gas which are destroyed thereby; and,
moving the heat gun over the entire surface for destroying the weeds and vegetation associated therewith.

11. The method according to claim 10 further comprising:
mixing water with the combustion exhaust gas for generating steam, and contacting and instantaneously heating the weeds and unwanted vegetation with the mixture of the combustion exhaust gas and steam which are destroyed thereby.

12. The method according to claim 10 further comprising filtering intake air supplied to the turbojet engine.

13. The method according to claim 10 further comprising providing a shield for directing the combustion exhaust gas over a predetermined area of the surface.

14. The method according to claim 10 further comprising mounting an adjustable ballast weight on the frame for counteracting a lifting force from discharge of the combustion exhaust against the surface receiving the treatment.
